(19) United States
(12) Patent Application Publication
(10) Pub. No.: US 2012/0305813 A1
(43) Pub. Date: Dec. 6, 2012

(54) ARRANGEMENT FOR AUTOMATIC HANDLING OF RADIOACTIVE MATERIALS

(75) Inventors: Roger Knopp, Berlin (DE); Kerstin Tautz, Oranienburg OT Lehnitz (DE)

(73) Assignee: Eckert & Ziegler Eurotope GmbH, Berlin (DE)

(21) Appl. No.: 13/482,329

(22) Filed: May 29, 2012

(30) Foreign Application Priority Data
May 31, 2011 (DE) 10 2011 076 808.4

(51) Int. Cl. G21F 5/14

(52) U.S. Cl. 250/506.1

(57) ABSTRACT

An arrangement for automatic handling of a radioactive material includes a shielding unit, at least one handling unit arranged inside the shielding unit, and an operating unit arranged outside the shielding unit and configured to operate the at least one handling unit. Only the handling unit or parts of the handling unit are in contact with the radioactive material. The arrangement for automatic handling of radioactive materials can be used for fully automatic process control, including physical and/or chemical operations, on radioactive fluids inside shielding. Self-shielded synthesis modules or dispensers can thus be provided for handling and processing radioactive fluids.

### CROSS-REFERENCES TO RELATED APPLICATIONS

This application claims the priority of German Patent Application, Serial No. 10 2011 076808.4, filed Mar. 31, 2011, pursuant to 35 U.S.C. 119(a)-(d), the content of which is incorporated herein by reference in its entirety as if fully set forth herein.

### BACKGROUND OF THE INVENTION

The present invention relates to an arrangement for automatic handling of radioactive materials, which can be used, in particular, for a fully automated process control on radioactive fluids inside shielding, wherein the process control includes physical and/or chemical operations. With the invention, in particular self-shielded synthesis modules or dispensers for handling and processing radioactive fluids can be provided.

The following discussion of related art is provided to assist the reader in understanding the advantages of the invention, and is not to be construed as an admission that this related art is prior art to this invention.

When handling radioactive materials with high activities, the operators and the environment must be protected from radioactive radiation. For this purpose, shielding made of materials with a high specific density, such as lead, tungsten or uranium and with required wall thicknesses of at least 5 cm is used. Conventional shielding, so-called “hot cells”, have therefore a weight of several tons. This shielding must significantly reduce the radiation in all spatial directions and must not have a radiation pass. Physical and chemical operations inside the shielding must be carried out through manipulation via manipulators or via fully automatic systems disposed inside the shielding (e.g. synthesis modules, dispensers, robots). However, a fully automatic process control of complicated flows, such as with multi-stage chemical syntheses, is not possible with manipulators. Fully automatic systems (e.g. synthesis modules, dispensers, robots) are operated inside the shielding (see FIG. 1) and thus increase the volume to be shielded and hence also the weight of the required shielding.

The state-of-the-art in the field of fully automatic process control of physical and chemical operations on radioactive fluids inside shielding is characterized in that, although fully automatic systems such as robots, synthesis devices and filling devices are available, all of the elements required for moving components are permanently located inside the shielding. In particular, synthesis modules for operating disposable cassettes, except for the control unit, are installed totally inside the shielding (see FIG. 1).

The conventional solutions have, inter alia, the following disadvantages:

Components operated inside the shielding significantly increase the volume to be shielded and hence the weight of the required shielding.

Electrical and electronic components inside the shielding are unprotected from radioactivity and are damaged or destroyed by radiation effects.

Radioactive contamination of components permanently installed inside the shielding can result in increased radiation doses inside the shielding. Contaminated components must be cleaned or disposed of, which is complicated and expensive.

It would therefore be desirable and advantageous to obviate prior art shortcomings and to provide an improved arrangement for automatic handling of radioactive materials and which, in particular, allows a more flexible application of such arrangement.

### SUMMARY OF THE INVENTION

According to one aspect of the present invention, an arrangement for automatic handling of a radioactive material includes a shielding unit, at least one handling unit arranged inside the shielding unit, and at least one operating unit arranged outside the shielding unit and configured to operate the at least one handling unit. Only the at least one handling unit or parts of the at least one handling unit are in contact with the radioactive material.

The flexible applicability of the arrangement of the invention is achieved in that the arrangement for automatic handling of radioactive materials includes at least one shielding unit, at least one handling unit and at least one operating unit. The at least one shielding unit is hereby constructed such that radioactive radiation emanating from materials disposed inside the at least one shielding unit is attenuated to a predeterminable level or only a predeterminable intensity reaches the outside. The predeterminable level may be defined by freely set values or by regulatory requirements. According to a preferred embodiment, shielding in all spatial directions with a dose rate of less than 10 μSv/h is realized at the surface outside the at least one shielding unit. Advantageously, the at least one shielding unit is made from a material having a high specific density. Advantageously, the material contains at least lead, tungsten or uranium. The arrangement according to the invention, in particular the at least one shielding unit, does not have a radiation pass. The at least one shielding unit is preferably constructed as a so-called “hot cell.”

According to an advantageous feature of the present invention, the at least one shielding unit may include a waste container for storing undesirable residues of radioactive materials produced during handling. The shielded waste container may be arranged inside or on the outside wall of the at least one shielding unit.

According to another advantageous feature of the present invention, at least during handling, the at least one handling unit may be arranged inside the at least one shielding unit and the at least one operating unit may be arranged outside the at least one shielding unit. In this way, the at least one shielding unit advantageously has dimensions and hence also a weight that are reduced significantly compared to conventional “hot cells.” According to another advantageous feature of the present invention, only the at least one handling unit or only parts of the at least one handling unit come into contact with radioactive materials, however not the at least one shielding unit or the at least one operating unit. This is advantageous in particular because the parts disposed outside the at least one shielding unit are not exposed to the radioactive radiation and the at least one shielding unit is also contaminated by only a small amount of radioactivity. After one handling operation terminated, the apparatus is then quickly available for the next application, because difficult decontamination is not required.

According to an advantageous feature of the present invention, the at least one operating unit may include, for example, several drive units, motors and/or electrical or electronic components. In one advantageous embodiment of the invention, a special drive unit may be employed for each of the at least one handling unit, for example a valve manifold, a syringe, a heating reactor and the like. According to another advantageous feature of the present invention, the drive units may be implemented, for example, as a control module for a valve manifold, a control module for operating a syringe or a control module for operating a heating module.

According to an advantageous feature of the present invention, the at least one handling unit may be of modular construction. Advantageously, the at least one handling unit may include at least one of the following components or modules (individually or in combination): distribution means, such as cocks, in particular one or more cock manifolds, syringes, connecting elements, in particular hoses, containers, in particular containers filled with reaction chemicals or products containers, a cleaning unit, for example a cleaning cartridge, filters, mounting elements, for example a holder, and the like. Advantageously, several components may be combined to an assembly. For example, the cocks or valve manifolds may be combined with a connecting element to a so-called cassette. In addition to cocks or one or more valve manifolds, a cassette may also include one or several syringes.

According to another advantageous feature of the present invention, at least a portion of the components may be constructed as disposable components, preferably disposable cassettes, and more particularly disposable synthesis cassettes which are offered for a variety of syntheses. Such disposable synthesis cassettes have therefore different components depending on the synthesis to be performed.

According to an advantageous feature of the present invention, the at least one handling unit may be operated with the at least one operating unit arranged outside the at least one shielding unit. For this purpose, means for force transmission, for example axles, such as rotary axles, are passed through a wall of the at least one shielding unit. The means for force transmission are positively or non-positively connected with the at least one handling unit inside the at least one shielding unit. According to an advantageous feature of the present invention, at least a portion of the means for force transmission and of the at least one handling unit may be releasably connected with one another. Advantageously, at least a portion of the feedthroughs for the means for force transmission may be implemented commensurate with at least a portion of the at least one handling unit. According to yet another advantageous feature of the present invention, a (standardized) grid spacing may be employed. Advantageously, at least a portion of the feedthroughs may be arranged such that certain modules of the at least one handling unit match these feedthroughs. For example, the feedthroughs for one or several valve manifolds, syringe modules, cassettes, connecting elements, containers and the like may be designed such that these components or modules can be readily combined with the means for force transmission passing through the feedthroughs, for example placed onto these means.

According to an advantageous feature of the present invention, the feedthroughs may have a use state and a non-use state. In the use state, a means for force transmission, which connects the at least one operating unit and the at least one handling unit with each other and provides an optional connection to the at least one handling unit inside the at least one shielding unit, is arranged in the feedthrough. In the non-use state, inserts providing shielding are preferably arranged in the feedthrough. The feedthroughs do not have a radiation pass in either the use state or the non-use state. According to an advantageous feature of the present invention, the means for force transmission includes shielding elements which, when in use, are arranged outside the at least one shielding unit and completely cover the feedthrough. The inserts may also have a coverage area which completely covers the feedthrough when the insert is disposed inside the feedthrough. According to yet another advantageous feature of the present invention, the shielding elements and/or the shielding areas may be constructed so as to overlap the feedthrough. Preferably, the shielding elements and/or the coverage areas may be produced from a material having a high specific density. Advantageous, the material may contain at least lead, tungsten or uranium. The feedthroughs may advantageously be used in the use state and the non-use state commensurate with the operating and handling means required for handling. Advantageously, the means for force transmission only pass through the feedthroughs when this is required for handling. The at least one shielding unit may have feedthroughs in all walls, but may have feedthroughs only in the sidewalls and the ceiling. In another advantageous embodiment, the at least one shielding unit may include a door, preferably a sliding door. In this situation, the sliding door advantageously does not have feedthroughs. In another advantageous embodiment, the at least one shielding unit may be constructed to be airtight. The feedthroughs and doors are then sealed.

According to another advantageous embodiment of the apparatus, the apparatus may be operated under vacuum.

According to an advantageous feature of the present invention, a laminar flow, i.e. a low-turbulence unidirectional air flow, may be realized inside the at least one shielding unit. For this purpose, the at least one shielding unit may be equipped with an air circulation system with filter(s), wherein the filter(s) is/are preferably shielded from the radiation.

Handling may include performing physical and/or chemical operations, performing a preferably multistage synthesis, such as a (multistage) chemical synthesis. One example for a synthesis may be the synthesis of radioactive diagnostic materials, such as PET tracers (PET=positron emission tomography). Advantageously, handling may be automatic, and even fully automatic. For controlling handling, in particular for controlling the at least one operating unit, the apparatus may advantageously include at least one data processing device.

The apparatus of the invention obviates the disadvantages of the state-of-the-art by arranging only holders for disposable cassettes and the disposable cassettes themselves inside the shielding. This significantly reduces the volume and weight of the shielding compared to the shielding required for conventional synthesis modules based on disposable cassettes. Electrical or electronic components located outside the shielding are protected from radioactivity. In the event of contamination, disposable cassettes can be easily removed and disposed of.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a conventional “hot cell”,

FIG. 2 shows a structure of an exemplary embodiment of the apparatus according to the present invention,

FIG. 3 shows another exemplary embodiment of the apparatus according to the present invention,

FIG. 4 illustrates the cooperation of a cassette with two valve manifolds with the axles of a control unit,

FIG. 5 shows an example of a disposable cassette with two valve manifolds, and

FIG. 6 shows an example of a disposable cassette with three valve manifolds.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

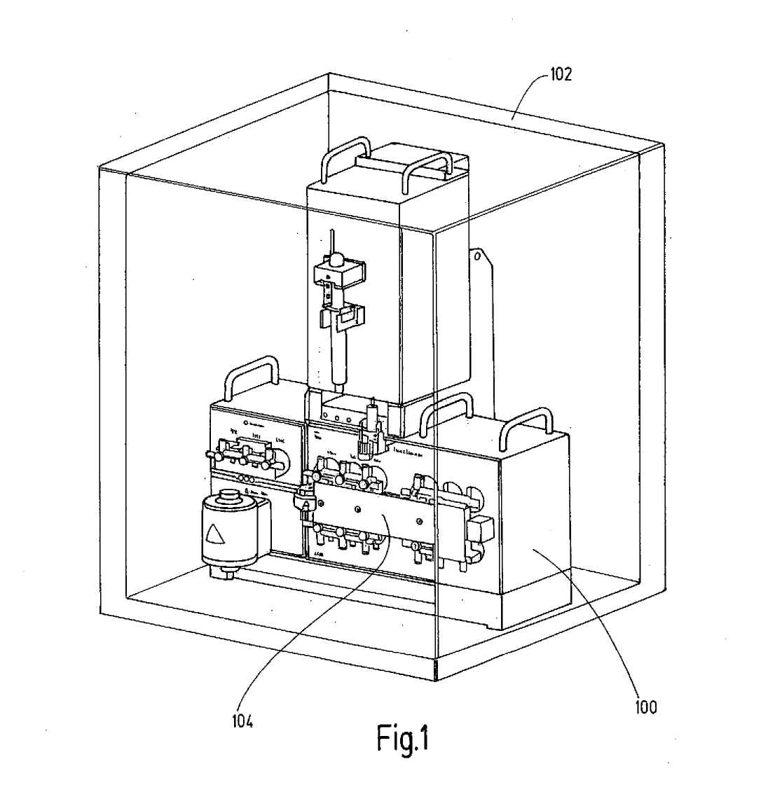

Before describing the invention in greater detail, the present state-of-the-art in the technical field of the invention will now be described again. Synthesis modules 100 for processing radioactive materials automatically or fully automatically are typically operated for radiation protection entirely inside shielding 102 (“hot cell”) which is shielded in all spatial directions. FIG. 1 illustrates a synthesis module 100 for disposable cassettes 104, wherein a portion of the shielding is not shown. As illustrated in FIG. 1, all components required for the kinematic operation of the components of the disposable cassettes 104 are permanently arranged inside the shielding 102, with the exception of possibly data processing devices, for example control units, which are in part also used outside the shielding.

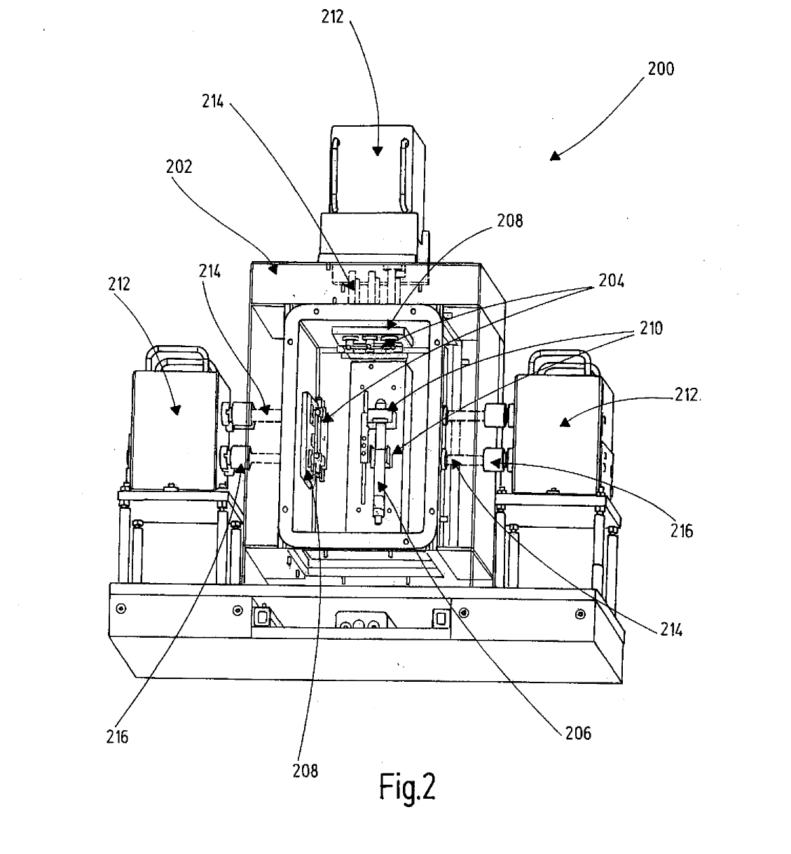

According to the present invention, unlike with conventional solutions, only those parts of a synthesis module 200 are arranged inside shielding 202 which come into contact with radioactive materials. Such parts are, for example, cassettes 204 with valve manifolds and/or syringes 206. The cassettes 204 with valve manifolds and/or the syringes 206 are in the exemplary embodiment attached to holders 208, 210. These holders 208, 210 are preferably removable from the shielding 202. The synthesis module 200 illustrated in FIG. 2 has three drive units 212 as operating units, which are connected via the axles 214 with the cassettes 204 having valve manifolds and the syringe 206. The drive units 212 are disposed outside the shielding 202. The axles 214 of the drive units 212 pass through the sidewalls and through the ceiling of the shielding. The axles 214 also include shielding elements 216 which completely cover the feedthroughs and prevent radiation from reaching the environment through the feedthrough (see FIG. 2). According to the invention, the shielding 202 shields the radiation in all spatial directions during handling. To improve clarity, part of the shielding is omitted in FIG. 2.

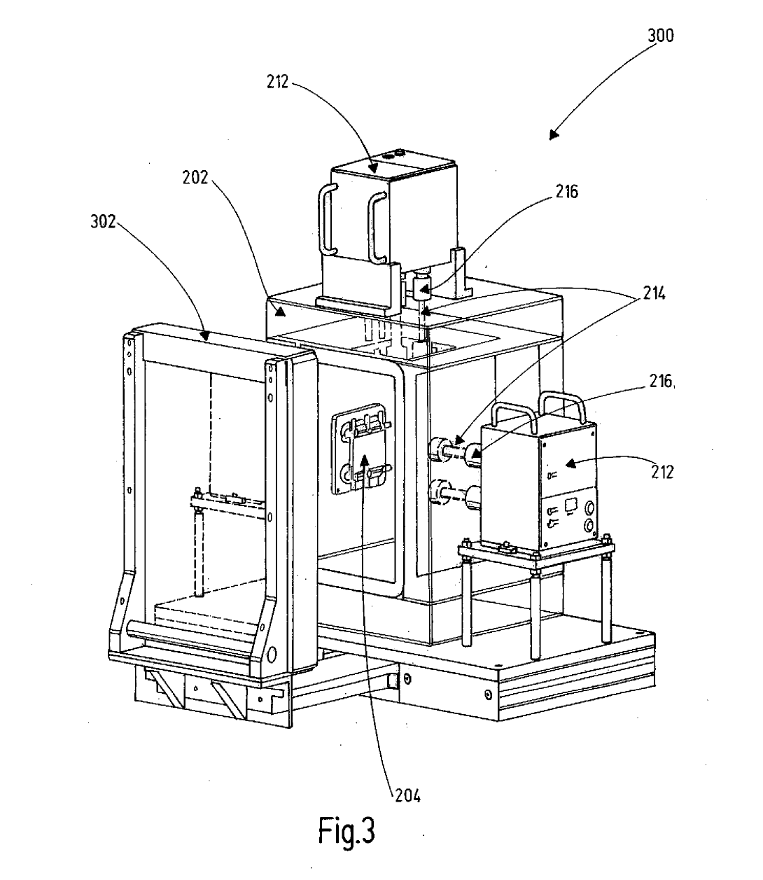

FIG. 3 shows another exemplary embodiment of the invention. The synthesis module 300 illustrated in FIG. 3 also includes drive units 212. However, components for performing the synthesis are not yet arranged inside the shielding 202. The exemplary synthesis module 300 includes a door 302, which enables access to the interior of the shielding 202. In this exemplary embodiment, the door 302 is implemented as a sliding door.

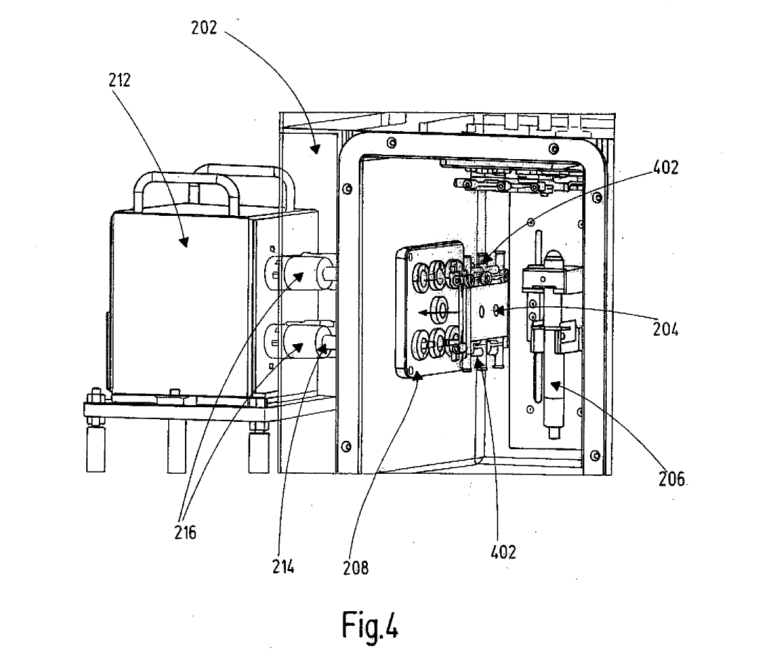

FIG. 4 shows in a detailed diagram the cooperation of drive unit 212, the axles 214, the holder 208 and a cassette 204 with the two valve manifolds 402.

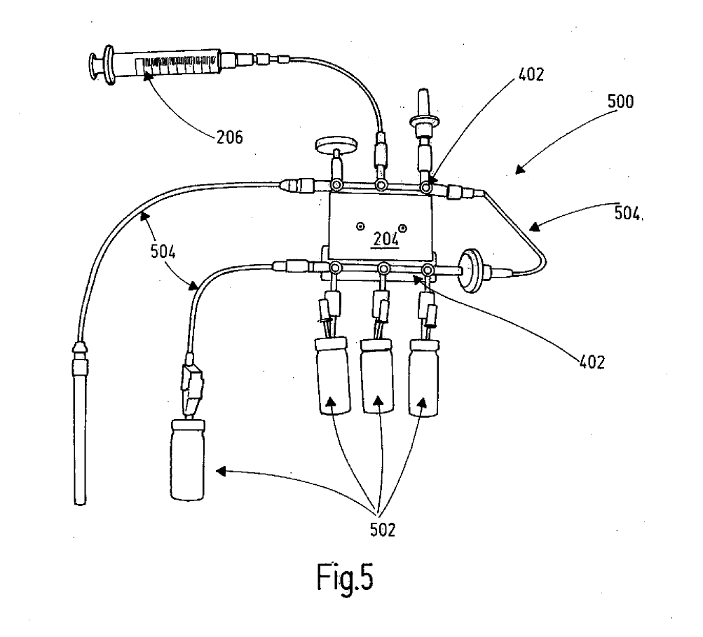

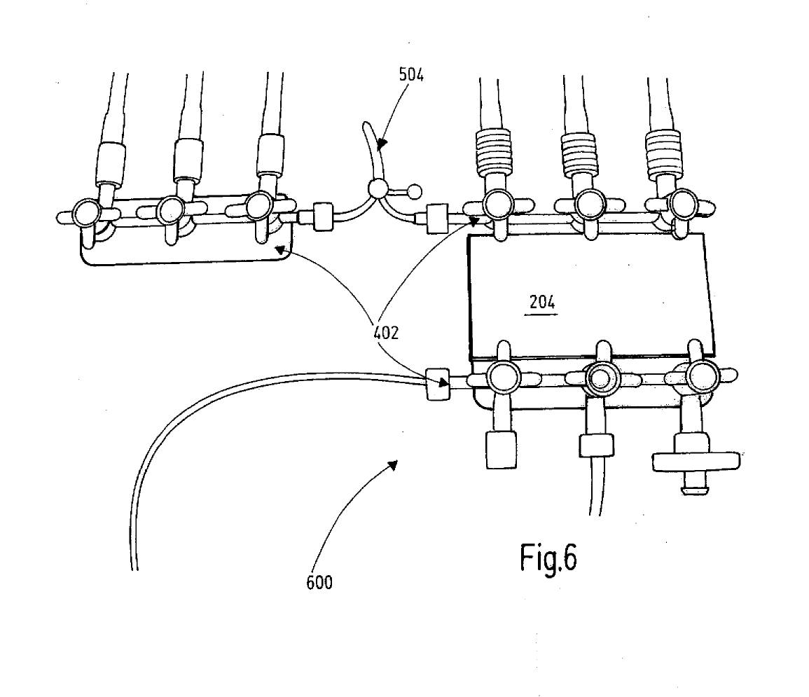

Two examples of disposable cassettes 500, 600 are illustrated in FIGS. 5 and 6. FIG. 5 shows a disposable cassette 500 which is combined with two valve manifolds 402, a syringe 206 and four containers 502 via a hose connection 504. The containers 502 may contain process chemicals or may be used as a (shielded) product container into which the finished product is filled. The disposable cassette 600 illustrated in FIG. 6 is combined with three valve manifolds 402. The design and configuration of the disposable cassettes 500, 600 depend on the synthesis steps to be performed. The employed drive units 212, holders 208, 210 and the employed feedthroughs are preferably also selected depending on the respective synthesis steps to be performed.

To protect the operators and the environment from radioactive radiation when handling radioactive materials with high activities, shielding 202 made of materials with a high specific density, for example lead, tungsten or uranium and with required wall thicknesses of at least 5 cm is used. The shielding 202 must significantly reduce the radiation in all spatial directions and must not have a radiation pass. According to the present invention, the dimensions and the weight of the shielding 202 can be reduced by placing only the parts in contact with the radioactive fluid, such as the valve manifolds 402, the syringes 206, the hose connection 504 or the containers 502 of the fully automatic apparatus inside the shielding 202, whereas all required manipulations are performed through the shielding 202 with components arranged on the outside, in particular drive units 202 and one or more control units. To this end, for example cassettes 204 with cocks or valve manifolds 402 and one or several syringes 206 are attached to holders 208, 210 disposed inside the shielding 202. The individual valves or the valves in a valve manifold 402 are driven by the axles 214 of externally mounted motors. The syringes 206 are also operated with drives from the outside. The feedthroughs of all drive units 212 to the driven units are designed without a radiation pass so as not to reduce the shielding effect. In particular, the axles have for this purpose shielding elements 216. The shielding 202 can be opened with a door 302 (see FIG. 3), the cassettes 204 with valves, valve manifolds 402, hose connections, connectors, containers 502 (filled with process chemicals), product container, cleaning cartridges, filters, syringes 206, etc. (see FIGS. 5 and 6), are inserted in the holders 208, 210, and the door 302 is closed. All steps required for carrying out the physical and chemical operations are performed through the shielding 202 by a fully automatic, computer-controlled system from the outside of the shielding 202. After the performed processes are concluded, the desired product is transferred into a shielded container 502 and unwanted residues of radioactive fluid are flushed in the best possible way into a likewise shielded waste container arranged inside or outside the shielding 202 of the system. With this approach, the door 302 of the shielding 202 can be safely opened shortly after conclusion of the process, the product can be removed, the cassettes 204 which are only slightly radioactive can be quickly disposed of, and the system can thus be made operational for the next application.

In particular, the invention is distinguished from conventional solutions in that a portion of the elements, preferably all elements, required for moving components of the synthesis module 200, 300 are arranged outside the shielding 202.

While the invention has been illustrated and described in connection with currently preferred embodiments shown and described in detail, it is not intended to be limited to the details shown since various modifications and structural changes may be made without departing in any way from the spirit and scope of the present invention. For example, the invention is not limited to an apparatus for carrying out a synthesis with radioactive materials, but the invention also includes apparatuses for other ways of handling radioactive materials The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An arrangement for automatic handling of a radioactive material, comprising:
a shielding unit,
at least one handling unit arranged inside the shielding unit, and
at least one operating unit arranged outside the shielding unit and comprising drive elements as force-transmitting elements to operate the at least one handling unit,
wherein only the at least one handling unit or parts of the at least one handling unit are in contact with the radioactive material,
wherein the shielding unit comprises feedthroughs for connecting the drive elements with the at least one operating unit and operating the at least one handling unit,
wherein at least a portion of the feedthroughs are arranged in a grid pattern with a spacing between the feedthroughs, and
wherein the drive elements are configured to be removed from the feedthroughs depending on operating elements of the at least one operating unit and handling elements of the at least one handling unit required for handling the radioactive material, with the removed drive elements being replaced by inserts blocking passage of radiation.

2. The arrangement of claim 1, wherein at least a portion of the feedthroughs and at least a portion of the at least one handling unit are matched to one another.

3. The arrangement of claim 1, wherein the grid pattern is matched to at least two different disposable cassettes.

4. The arrangement of claim 1, wherein the at least one handling unit is of modular construction or comprises different components.

5. The arrangement of claim 1, wherein the at least one operating unit comprises at least one drive or at least one control unit, or both.

6. The arrangement of claim 1, wherein the at least one handling unit comprises at least one element selected from a distribution means, a syringe, a connecting element, a container, a cleaning unit and a filter.

7. The arrangement of claim 1, wherein at least a portion of the at least one operating unit comprises electrical or electronic components, or both.

8. The arrangement of claim 1, wherein the at least one handling unit is configured to perform an operation selected from physical operations, chemical operations, processing the radioactive material and synthesis of the radioactive material.

9. The arrangement of claim 1, wherein the at least one shielding unit shields radiation in all spatial directions.

10. The arrangement of claim 1, wherein the at least one shielding unit comprises a waste container.
